(19) United States
(12) Patent Application Publication
(10) Pub. No.: US 2006/0064888 A1
(43) Pub. Date: Mar. 30, 2006

(54) Level device and method for displaying leveling

(76) Inventor: Timmy Chen, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/948,242

(22) Filed: Sep. 24, 2004

(51) Int. Cl. G01C 9/10

(52) U.S. Cl. 33/365

(57) ABSTRACT

A level includes a display screen and a control portion. The display screen has a central area which is located at a center of a cruciform of two groups of horizontal display units and two groups vertical display units. A plurality of display bars are located on two sides of each group of horizontal units and arrow-head-shaped horizontal indications are located at two respective remote ends away from the central area of the horizontal display units. The display screen includes a memory area (Memory), an alarm set area (SP), a calibration area (CAL), a resolution area (Resol), a pitching area (Pitch), and a rolling area (Roll). The control portion includes a mode button (MODE), a reset button (MEMO/SET), a calibration button (CAL) and an alarm set button (SP).

### FIELD OF THE INVENTION

The present invention relates to a level device and a method for displaying leveling, and more particularly, to a level with multiple displaying units for displaying detail data.

### BACKGROUND OF THE INVENTION

A conventional level generally includes a frame with a plurality of level vials connected thereto and each vial receives liquid therein and a bubble formed in the liquid so that the users check the position of the bubble to adjust the objects. Nevertheless, it requires experience to check the position of the bubble, especially for checking an inclined surface. Furthermore, the bubble is not stable and could divide into multiple tiny bubbles which confuse the users to read. Some electronic level devices are developed and display the data by digits which include a range of tolerance.

U.S. Pat. No. 5,594,669, issued on Jan. 14, 1997 discloses an electronic ievel which utilizes two sensors located perpendicular to each other to check two joint surfaces of an object. Digits are displayed on the cruciform scales. However, the electronic level is suitable for leveling two orthogonal surfaces and is not suitable if the two surfaces of the object are not orthogonal to each other. Furthermore, the electronic level cannot display the direction that the surface inclines.

The present invention intends to provide a level and a method for displaying leveling, wherein multiple display units are involved and can be reset for different modes.

### SUMMARY OF THE INVENTION

The present invention relates to a level includes a display screen with a central area which is located at a center of a cruciform of two groups of horizontal display units and two groups vertical display units and a control portion, and a control portion which includes a mode button (MODE), a reset button (MEMO/SET), a calibration button (CAL) and an alarm set button (SP). A plurality of display bars are located on two sides of each group of horizontal units and arrow-head-shaped horizontal indications are located at two respective remote ends away from the central area of the horizontal display units. The display screen further includes a memory area (Memory), an alarm set area (SP), a calibration area (CAL), a resolution area (Resol), a pitching area (Pitch), and a rolling area (Roll).

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the level device of the present invention;

FIG. 2 shows the arrangement of the various portion on the display portion of he level of the present invention;

FIG. 3 shows a flow chart of the steps of the operation of the level of the present invention;

FIG. 4 shows the display of the display screen when checking an inclined surface, and

FIG. 5 shows the display of the display screen when checking a horizontal surface.

### DETAILED DESCRIPTION OF THE PREFERRED EMBODIMENT

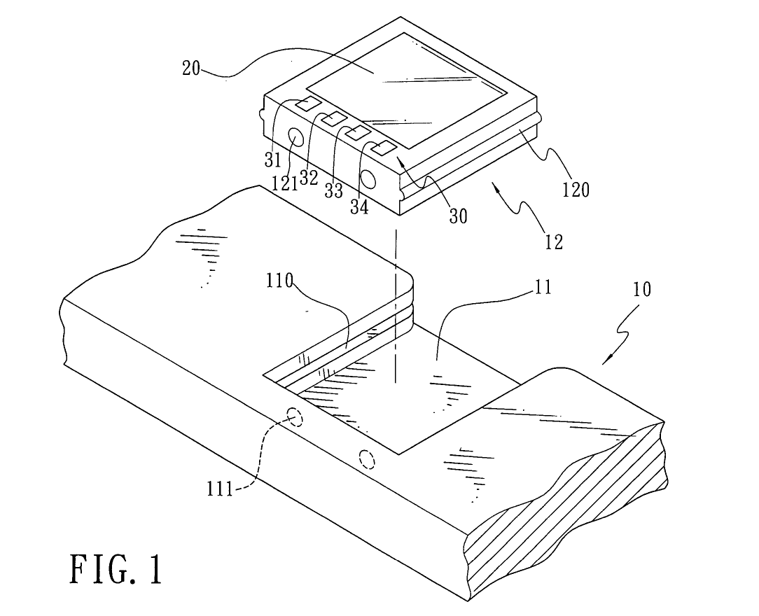

Referring to FIG. 1, the level device of the present invention comprises a frame 10 with a recess 11 defined therein and two attraction members such as two first magnetic members 111 are embedded in an inside of the recess 11. A level 12 is received in the recess 11 and includes two attraction members such as two second magnetic members 121 which are magnetically connected to the first magnetic members 111. The frame 10 and the level 12 are connected with each by an engaging mechanism which comprises two ridges 120 on two sides of the level 12 so as to be slidably received in two grooves 110 in the two opposite insides of the recess 11 to position the level 12 in position.

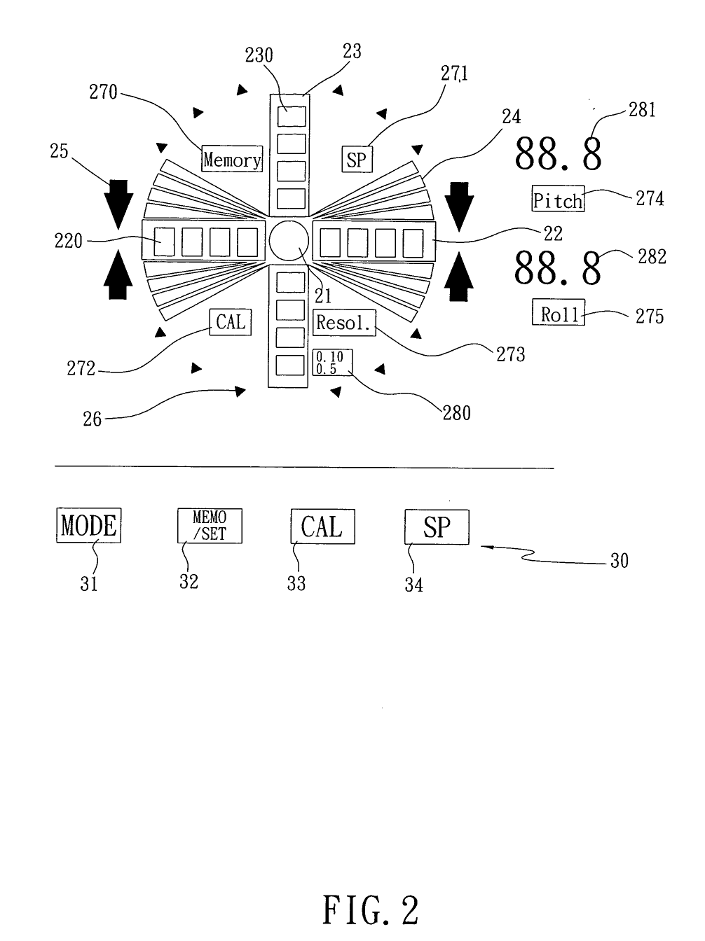

As shown in FIG. 2, the level 12 includes a display screen 20 and a control portion 30. The display screen 20 has a central area 21 which is located at a center of a cruciform of two groups of horizontal display units 22 and two groups vertical display units 23. A plurality of display bars 24 are located on two sides of each group of horizontal units 22 and a pair of arrow-head-shaped horizontal indications 25 are located at two respective remote ends away from the central area 21 of the horizontal display units 22. Each group of the horizontal display units 22 and the vertical display unit 23 includes a plurality of display areas 220, 230. A plurality of surface horizontal indications 26 are located around the horizontal display units 22 and the vertical display units 23 at even angular distance.

The display screen 20 has a memory area 270 (Memory), an alarm set area 27i (SP), a calibration area 272 (CAL), a resolution area 273 (Resol), a pitching area 274 (Pitch), and a rolling area 275 (Roll). Some portions are displayed by digits or words, such as digits 280 being displayed resolution area 273 (Resol), digits 281 for displaying the pitch and digits 282 for displaying the rolling.

The control portion 30 has a mode button 31 (MODE), a reset button 32 (MEMO/SET), a calibration button 33 (CAL) and an alarm set button 34 (SP).

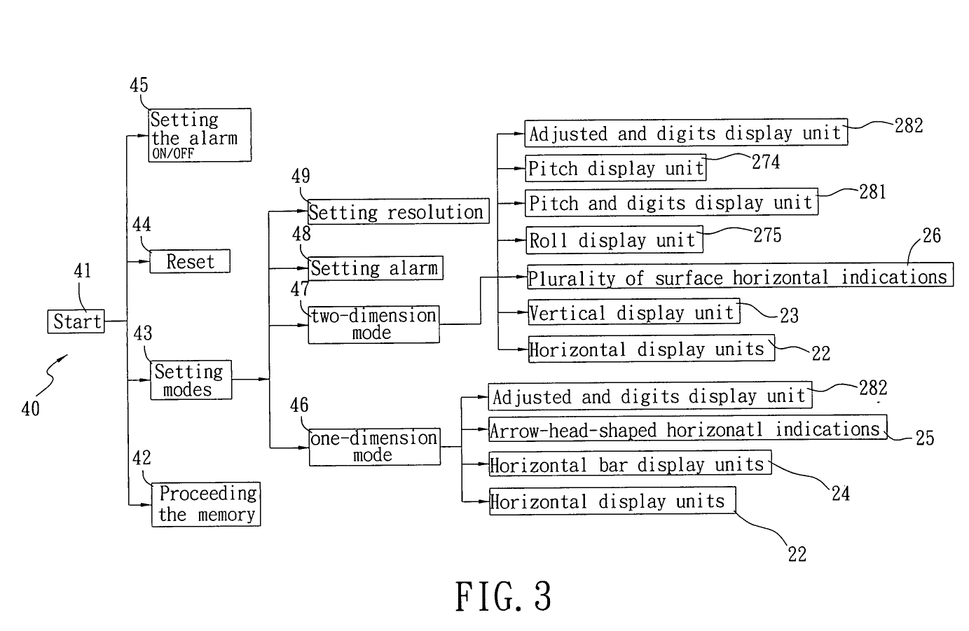

Referring to FIGS. 3, 4 and 5, the steps 40 that the control portion 30 takes are as follows:

Start 41: switch the power on;

Proceeding the memory 42: the device utilizing the previous memory if no button is pressed, the memory area 270 (Memory) being on;

Setting modes 43: the mode button 31 (MODE) being pressed to set a mode;

Reset 44: pressing the reset button 32 (MEMO/SET) to delete the previous memory and setting the desired mode, or pressing the reset button 32 (MEMO/SET) without using the mode button 31 (MODE) to set zero to the device, the calibration area 272 (CAL) being on, or shutting the power down;

Setting the alarm 45: pressing the alarm set button 34 (SP) to control the alarm in the device and the alarm set area 271 (SP) being on.

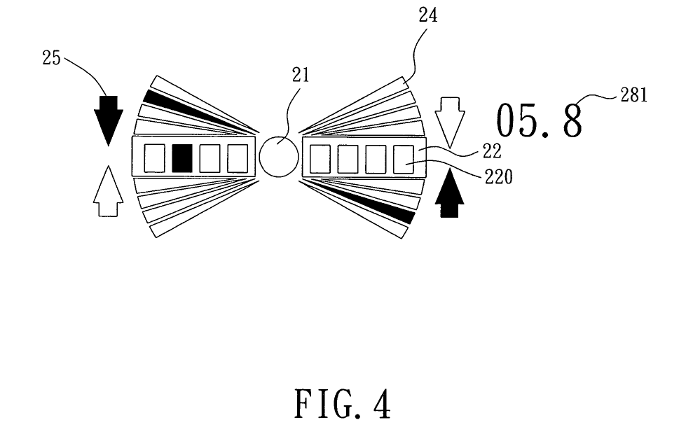

The mode setting includes one-dimension mode 46 and two-dimension node 47. The one-dimension mode 46 displays the horizontal display units 22, the display bars 24, the arrow-head-shaped horizontal indications 25 and digits 282 for displaying the rolling. As shown in FIG. 4, the display shows the surface to be checked is higher on the left and lower on the right. The third display area 220 is on, the arrow-head-shaped horizontal indications 25 show the direction to be adjusted and the digits 282 show the precise value of the inclination.

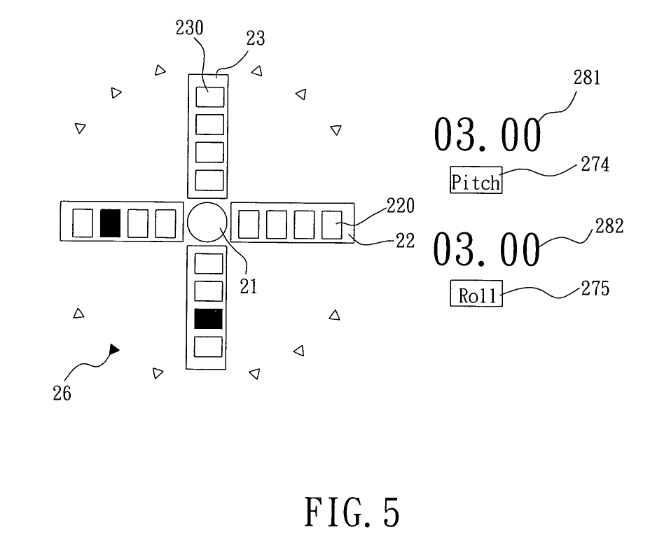

The two-dimension mode 47 displays the horizontal display units 22, the vertical display unit 23, surface horizontal indications 26, the pitching area 274 (Pitch), the rolling area 275 (Roll) and digits 281 of the rolling. This data includes two groups of information with three digits for convenience of reference for the users. As shown in FIG. 5, the level 12 is put on a surface, if the surface is tilt, the display areas 220, 230 of the horizontal display units 22 and the vertical display unit 23 show the inclination of the surface. The surface horizontal indications 26 shows the direction to be adjusted.

Setting alarm 48: the types or volume of audio of the alarm can be set;

Setting resolution 49: setting resolution of the display screen 20 by pressing the mode button 31 (MODE) and the reset button 32 (MEMO/SET). The digits 280 show the values that to be checked in the resolution area 273 (Resol). This allows the users to check the range to be checked so as to meet different requirements.

The result in the display screen 20 is easily read by displays and the level 12 suggests the directions to be adjusted. By using the resolution setting, the result shows the information of the inclination of the surface to be checked and is helpful to the users to adjust. The alarm allows the level 12 to remind the users about the situations that the surfaces to be checked.

While we have shown and described the embodiment in accordance with the present invention, it should be clear to those skilled in the art that further embodiments may be made without departing from the scope of the present invention.

What is claimed is:

1. A level device comprising:
a frame 10 with a recess 11 defined therein and two first attraction members embedded in an inside of the recess 11, a level 12 received in the recess 11 and including two second attraction members which are connected to the first attraction members.

2. The device as claimed in claim 1, wherein the first attraction members and the second attraction members are magnetic members 111, 121.

3. The device as claimed in claim 1, wherein the recess 11 and the level 12 are engaged with each other by engaging mechanism.

4. The device as claimed in claim 1, wherein the level 12 comprises two ridges 120 on two sides thereof and two grooves 110 are defined in the two opposite insides of the recess 11 such that the two ridges 120 are slidably engaged with the grooves 110.

5. A level device comprising:
a frame (10) with a recess (11) defined therein and a level (12) received in the recess (11), the level (12) including a display screen (20) and a control portion (30), the display screen (20) having a central area (21) which is located between two groups of horizontal display units (22), a plurality of display bars (24) located on two sides of each group of horizontal units (22).

6. The device as claimed in claim 5 further comprising arrow-head-shaped horizontal indications (25) located at two respective remote ends away from the central area (21) of the horizontal display units (22).

7. A level device comprising:
a display screen (20) and a control portion (30), the display screen (20) having a central area (21) which is located between two groups vertical display units (23).

8. The device as claimed in claim 7 further comprising two groups of horizontal display units (22) and the central area (21) located between two groups of horizontal display units (22), a plurality of surface horizontal indications (26) located around the horizontal display units (22) and the vertical display units (23).

9. The device as claimed in claims 5 or 7, wherein each group of the horizontal display units (22) and the vertical display unit (23) includes a plurality of display areas (220, 230).

10. A level device comprising:
a display screen (20) and a control portion (30), the display screen (20) having a memory area (270), an alarm set area (271), a calibration area (272), a resolution area (273), a pitching area (274), and a rolling area (275), digits (280) being displayed resolution area (273), digits (281) for displaying the pitch and digits (282) for displaying the rolling.

11. A level device comprising:
a display screen (20) and a control portion (30), the control portion (30) having a mode button (31), a reset button (32), a calibration button (33) and an alarm set button (34).

12. The device as claimed in claims 5, 7, 10 or 11, wherein the controlling steps are as follows:
Start: switch the power on;
Proceeding the memory: the device utilizing the previous memory if no button is pressed, the memory area (270) lighting on;
Setting modes: the mode button (31) being pressed to set a mode;
Reset: pressing the reset button (32) to delete the previous memory and setting the desired mode, or pressing the reset button (32) without using the mode button (31) to set zero to the device, the calibration area (272) lighting on, or shutting the power down;
Setting the alarm: pressing the alarm set button (34) to control the alarm in the device and the alarm set area (271) lighting on.

13. The device as claimed in claim 12, wherein the step of setting mode includes a one-dimension mode (46) which displays the horizontal display units (22), the display bars (24), the arrow-head-shaped horizontal indications (25) and digits (281) of the rolling.

14. The device as claimed in claim 12, wherein the step of setting mode includes a two-dimension mode (47) which displays the horizontal display units (22), the vertical display unit (23), surface horizontal indications (26), the pitching area (274), the rolling area (275) and digits (281) of the rolling.

15. The device as claimed in claim 12, wherein the step of setting mode includes a step of setting resolution which sets resolution of the display screen (20) by pressing the mode button (31) and the reset button (32), digits (280) being displayed resolution area (273).
